(19) United States
(12) Patent Application Publication
(10) Pub. No.: US 2026/0320546 A1
(43) Pub. Date: Oct. 15, 2026

(54) SYSTEM AND METHOD FOR FLEXIBLE AGENTIC AUTONOMOUS NEGOTIATION PROCESS

(71) Applicant: Zycus Infotech Pvt Ltd, Mumbai (IN)

(72) Inventors: Tejit Mithal, Mumbai (IN); Pridhvi Kare, Mumbai (IN); Durga Prasad, Mumbai (IN); Shabeesh Balan, Mumbai (IN)

(21) Appl. No.: 19/632,348

(22) Filed: Mar. 29, 2026

(30) Foreign Application Priority Data
Mar. 29, 2025 (IN) 202521030610

(51) Int. Cl. G06Q 10/087; G06Q 10/0631; G06Q 10/0635; G06Q 50/18

(52) U.S. Cl. CPC G06Q 10/087; G06Q 10/06316; G06Q 10/0635; G06Q 50/188

(57) ABSTRACT

A system and method for a flexible agentic autonomous negotiation process that orchestrates procurement negotiation workflow by leveraging procurement agents that continuously assess supplier behaviour, market trends, and historical data. The system comprises an input unit, a processing unit and an output unit wherein the processing unit employs the workflow for assisting procurement related negotiation by procurement agents. The method comprises the steps of entering the requirements in the input unit by the user; employing procurement agents that create customized procurement workflows based on specific business needs; creating a structured, intelligent, and autonomous orchestration of procurement tasks from initiation to contract finalization by the procurement agents; adding or removing procurement agents by users in the negotiation workflow; incorporating real-time supplier risk assessment into the negotiation process to mitigate procurement risks and ensure supply chain reliability; providing a comprehensive negotiation performance report upon finalizing the procurement event.

### CROSS-REFERENCE TO RELATED APPLICATION

The instant application claims priority to Indian Patent Application Serial No. 202521030610 filed Mar. 29, 2025, the entire specification of which is expressly incorporated herein by reference.

### TECHNICAL FIELD OF THE INVENTION

The present invention relates to a procurement negotiation process. More particularly the invention relates to a system and method for flexible agentic autonomous negotiation process that is an AI-powered agentic framework that enables self-driven, autonomous negotiation workflows.

### BACKGROUND: OF THE INVENTION

Procurement negotiation is a key business function where buyers and sellers define mutually agreeable terms before making a purchase. It entails pricing, delivery, and service expectations, requiring clear communication, bargaining, and compromise for a fair deal. The procurement negotiation process includes identifying suppliers, collecting bids, determining base price, setting negotiation parameters, and finalizing contracts.

Traditional negotiation workflows require procurement professionals to continuously monitor and approve each step which makes the process cumbersome, time-intensive and prone to inefficiencies and delays. There is also a lack of data-driven insights to monitor business news, monitor real-time price fluctuations, and compliance breaches as the traditional negotiation workflows rely heavily on human judgment which may lead to inconsistent pricing and supplier selection. Key limitations of traditional procurement negotiation include:
Manual bid collection and supplier evaluation leading to inefficiencies and delays.
Lack of dynamic negotiation strategies, relying solely on static pricing benchmarks.
Inability to factor real-time market trends and supplier risk intelligence into pricing discussions.
Limited automation, requiring human intervention at multiple touchpoints, increasing costs and processing time.

IN202521007133 discloses an intelligent decision-making framework for strategic sourcing, leveraging AI-powered procurement models to optimize supplier evaluation, mitigate risks, and enhance cost efficiency while aligning with sustainability goals. It provides supplier scoring, predictive cost modelling, risk management, and ESG evaluation, enabling procurement managers to make data-driven decisions to achieve efficient, resilient, and sustainable procurement operations.

U.S. Pat. No. 11,514,511 introduces systems and methods for autonomous bidder solicitation and selection in which a pro forma contract defined by a variables matrix of variables is created from a received procurement request. It scrapes the web to identify potential bidders based on the variables. It uses a single autonomous system for bidder solicitation, selection, and contract creation.

U.S. Pat. No. 9,767,511 discloses a system, method, and computer program product for automating an online auction service and bidder interaction. It allows bidders to monitor the status of an auction continually by automating the bidding process made available to bidders.

Prior arts hereinabove focus primarily on supplier selection, automating auctions, and efficient decision making supported by AI-driven data insights. The prior arts also provide a system and method for bidder solicitation and selection by scraping the web. However, these traditional systems lack a system where each step in the process is represented by an AI-driven automated agent that also adjusts the negotiation strategies based on data insights on market fluctuations, past transactions and compliance requirements. Further, there is a gap in automated workflows to meet real-time modification requirements in the procurement process to cater specific business cases and organizational policies and all the conventional systems require manual monitoring and intervention at each stage.

To overcome these drawbacks, it is essential to introduce a negotiation system which intelligently orchestrates the negotiation workflows without requiring manual intervention at each step thus ensuring a seamless, intelligent and optimized process for procurement negotiation. Thus, there is a need to introduce a system that integrates all steps of the procurement process to enable dynamic negotiation workflows by automating end-to-end contract execution to reduce unnecessary steps while maximizing process efficiency.

### OBJECTS OF THE INVENTION

The primary object of the present invention is to provide a system and method for flexible agentic autonomous negotiation process.

Another object of the invention is to provide a system and method for flexible agentic autonomous negotiation process that intelligently orchestrates procurement negotiations by leveraging AI-driven agents that continuously assess supplier behaviour, market trends, and historical data.

Another object of the invention is to provide a system and method for flexible agentic autonomous negotiation process that functions as a self-driven assistant that requires just one user command and input, after which all procurement activities are automatically executed through an agentic-driven flow.

Yet another object of the invention is to provide a system and method for flexible agentic autonomous negotiation process that is highly flexible, allowing both system-driven and user-driven modifications to the negotiation workflow which ensures that procurement activities remain adaptive to real-time business needs.

Yet another object of the invention is to provide a system and method for flexible agentic autonomous negotiation process that incorporates real-time supplier risk assessment into the negotiation process to mitigate procurement risks and ensure supply chain reliability.

### SUMMARY OF THE INVENTION

Before the present invention is described, it is to be understood that the present invention is not limited to particular methodologies and systems described herein, as these may vary as per the understanding of a person skilled in the art. It is also to be understood that the terminology used in the description is for the purpose of explaining specific embodiments and is not intended to limit the scope of the present invention.

The present invention describes a system and method for flexible agentic autonomous negotiation process. This system intelligently orchestrates procurement negotiations by leveraging procurement agents that continuously assess supplier behaviour, market trends, and historical data. The system focuses on providing deep value as a self-driven assistant that requires just one user command and input, after which all procurement activities are automatically executed through an agentic-driven flow.

According to an aspect of the present invention, the system comprises of a user, an input unit, a processing unit and an output unit wherein the processing unit employs a workflow for assisting procurement related negotiation. The user creates an input wherein the user communicates the requirement to the system and the automated procurement agents perform the methods of procurement including selection of suppliers, risk assessment, bid collection, price negotiation and contract execution. The system performs real-time assessment of the workflows based on the case of each business and policies and suggests recommendations.

According to an aspect of the present invention, the user may modify the workflows and the system performs compliance checks for these modifications. Thus, the system comprises multiple autonomous procurement agents that dynamically interact to execute procurement tasks. The procurement agents are dynamically configurable by the user, enabling the creation of customized procurement workflows based on specific business needs. The agentic approach allows procurement teams to operate with minimal human intervention, ensuring a structured, intelligent, and autonomous orchestration of procurement tasks from initiation to contract finalization.

### DETAILED DESCRIPTION OF THE INVENTION

Before the present invention is described, it is to be understood that this invention is not limited to the particular methodologies described, as these may vary as per the understanding of a person skilled in the art. It is also to be understood that the terminology used in the description is for the purpose of describing particular embodiments only and is not intended to limit the scope of the present invention. Throughout this specification, the word “comprise,” or variations such as “comprises” or “comprising,” will be understood to imply the inclusion of a stated element, integer, or step, or group of elements, integers, or steps, but not the exclusion of any other element, integer, or step, or group of elements, integers, or steps. The use of the expression “at least” or “at least one” suggests the use of one or more elements, agents, or quantities, as may be applicable to the embodiment of the invention to achieve one or more of the desired objects or results. Various embodiments of the present invention are described below. However, it is noted that the present invention is not limited to these embodiments; rather, modifications that are apparent to a person skilled in the art are also included.

The present invention describes a system and method for flexible agentic autonomous negotiation process. This is an AI-powered agentic framework that enables self-driven, autonomous negotiation workflows. Unlike traditional systems that require manual monitoring and intervention at each stage, this system intelligently orchestrates procurement negotiations by leveraging procurement agents that continuously assess supplier behaviour, market trends, and historical data. The system focuses on providing deep value as a self-driven assistant that requires just one user command and input, after which all procurement activities are automatically executed through an agentic-driven flow. The system eliminates the need for human intervention at each step, ensuring a seamless, intelligent, and optimized procurement process.

The system comprises of a user, an input unit, a processing unit and an output unit wherein the processing unit employs a workflow for assisting procurement related negotiation. The user creates an event wherein the user communicates the requirement to the system and the automated procurement agents perform the methods of procurement including selection of suppliers, risk assessment, bid collection, price negotiation and contract execution. The system performs real-time assessment of the workflows based on the case of each business and policies and suggests recommendations. The user may modify the workflows and the system performs compliance checks for these modifications. Thus, the system comprises multiple autonomous procurement agents that dynamically interact to execute procurement tasks. The procurement agents are dynamically configurable by the user, enabling the creation of customized procurement workflows based on specific business needs. The agentic approach allows procurement teams to operate with minimal human intervention, ensuring a structured, intelligent, and autonomous orchestration of procurement tasks from initiation to contract finalization.

According to the embodiment of the present invention, the method for flexible agentic autonomous negotiation process comprises the following steps. User enters the requirements in the input unit. The system then employs procurement agents that create customized procurement workflows based on specific business needs. The sequence of procurement agents creates a structured, intelligent, and autonomous orchestration of procurement tasks from initiation to contract finalization. Users can also add or remove agents in the negotiation workflow. The system also incorporates real-time supplier risk assessment into the negotiation process to mitigate procurement risks and ensure supply chain reliability. The system finally provides a comprehensive negotiation performance report upon finalizing the procurement event.

According to the embodiment of the present invention, the procurement agents are selected from create event agent, supplier selection agent, bid collection agent, negotiation agent, supplier risk agent, award agent, contract negotiation agent, etc. The procurement agents perform the following roles:
1. Create Event Agent: Generates a procurement event based on user input for item description, quantity, and timelines.

Example: A user requires 500 units of industrial-grade steel rods within 30 days. The system automatically initiates a procurement event with these details.
2. Supplier Selection Agent: Identifies eligible suppliers based on historical transactions, supplier performance ratings, and pre-configured supplier eligibility criteria.

Example: Based on past records, three suppliers with the best quality compliance and delivery performance are shortlisted.
3. Bid Collection Agent: Invites the shortlisted suppliers to submit their bids within a defined timeframe.

Example: Suppliers receive an automated bid request notification with submission deadlines and quality compliance requirements.
4. Negotiation Agent: Executes AI-driven negotiations with the top suppliers using dynamic pricing strategies. It determines a base price using:
Historical procurement data from previous similar purchases.
Live market price data from commodity indexes.
Previous bid records from suppliers.

It applies hard, medium, or easy negotiation modes based on the item type, supplier behaviour, and urgency of procurement.

Example: For high-demand steel rods, the system applies hard negotiation, sending counteroffers to suppliers based on past pricing trends and competitive market rates.
5. Supplier Risk Agent (Optional, Case-Based Activation): Assesses supplier risks only when a potential risk is detected based on system assessment.

Example: If Supplier A has a recent financial instability alert or regulatory compliance issue, the agent automatically flags the risk, removes the supplier from negotiations, and recommends an alternative supplier.
6. Award Agent: Automatically finalizes the procurement award based on the best-negotiated price and supplier risk assessment.

Example: After multiple negotiation rounds, Supplier B is awarded the contract for offering the best price and delivery schedule.
7. Contract Negotiation Agent: Facilitates contract execution post-negotiation, ensuring compliance and finalization of terms.

Example: The system auto-generates a procurement contract, aligns it with pre-approved legal clauses, and routes it for e-signature approval.

According to the embodiment of the present invention, the system of the present invention is designed to be highly flexible, allowing both system-driven and user-driven modifications to the negotiation workflow. This ensures that procurement activities remain adaptive to real-time business needs. The following features of the system attribute to the flexibility of the system:
Dynamic Agent Activation: The system introduces new agents based on real-time requirement assessments. For example, the Supplier Risk Agent is only introduced when a supplier shows risk indicators like financial instability or past non-compliance.
User-Driven Customization: Users can add or remove agents in the negotiation workflow. For instance, if contract negotiation is handled externally, the user can choose to delete the Contract Negotiation Agent from the process.
Configurable Execution: The system enables organizations to define which agents should be activated for specific procurement categories, supplier types, or deal values, ensuring optimal efficiency.

This flexibility ensures that procurement workflows can be dynamically tailored to specific business cases and organizational policies, reducing unnecessary steps while maximizing process efficiency.

According to the embodiment of the present invention, the Negotiation Agent automatically shortlists the top suppliers based on pricing, past performance, delivery timelines, and risk assessment. The negotiation agent sets a base price derived from multiple sources:
Historical procurement data from past transactions: The system retrieves past procurement records stored in an internal database, categorizing transactions by item type, quantity, supplier, and price trends over time. A machine learning model evaluates historical price variations and purchasing patterns to establish a baseline price.
Publicly available market price quotes: The system integrates with external APIs that pull live pricing information from commodity exchange platforms, supplier marketplaces, and industry reports. This ensures the pricing model reflects current market conditions.
Supplier-provided bids in previous procurement cycles: The system maintains a repository of past bid submissions from various suppliers. A comparative pricing analysis evaluates past bid trends for similar products, identifying pricing behaviour and supplier competitiveness.

The negotiation agent then initiates price discussions, asking suppliers to provide counteroffers based on this base price. The system determines the appropriate negotiation mode to be used based on the item category, supplier type, historical procurement records, heuristic patterns, market trends, and supplier discount history.

According to the embodiment of the present invention, the system evaluates prior interactions with suppliers, their pricing flexibility, and their negotiation behaviours to select one of the following negotiation strategies:
Hard Negotiation: Focused on maximum cost savings with aggressive counteroffers. Used for high-margin items, low-risk suppliers, and price-competitive markets.
Medium Negotiation: Balanced approach that considers long-term supplier relationships while optimizing pricing. Applied to strategic suppliers or procurement where long-term reliability is a key factor.
Easy Negotiation: Ensures faster deal closures with reasonable pricing adjustments. Used for time-sensitive procurement needs or cases where supplier constraints limit pricing flexibility.

Multiple negotiation rounds are conducted, dynamically adjusting the negotiation approach based on supplier responses. The system also applies bundling and unbundling techniques, analysing whether items should be negotiated as a package for bulk discounts or separately to achieve the best pricing for individual components. The system tracks supplier behaviour in real time, adjusting counteroffers and leveraging strategic pauses to optimize negotiation results. The AI-powered risk mitigation of the system ensures that suppliers flagged with financial instability or prior compliance issues are handled with additional scrutiny, preventing potential disruptions in procurement.

According to the embodiment of the present invention, the system and method for flexible agentic autonomous negotiation process also incorporates real-time supplier risk assessment into the negotiation process to mitigate procurement risks and ensure supply chain reliability. The system continuously monitors supplier performance, financial health, regulatory compliance, and market reputation. If a selected supplier has negative financial indicators, legal disputes, or recent supply chain disruptions, the Supplier Risk Agent can automatically:
Reject the supplier from the negotiation process.
Introduce an alternative supplier into the workflow.
Trigger additional risk mitigation measures, such as requesting updated compliance documents or conducting enhanced due diligence.

The Supplier Risk Agent assesses risk by:
Analysing real-time business news for legal or financial red flags.
Evaluating past procurement records for delayed deliveries, price fluctuations, or compliance breaches.
Conducting automated supplier risk scoring, flagging high-risk vendors for further review.

If a supplier is flagged as high-risk, the system can automatically eliminate them from negotiations and bring in a replacement supplier, ensuring minimal disruption to procurement timelines. The system also provides an automated risk report summarizing:
Suppliers rejected due to risk factors.
Justifications for replacements.
Recommendations for future supplier engagement.

This intelligent risk assessment mechanism ensures that procurement teams make informed, data-driven decisions, protecting supply chains from potential disruptions.

According to the embodiment of the present invention, the system and method for flexible agentic autonomous negotiation process also provides a comprehensive negotiation performance report upon finalizing the procurement event. This report showcases:
Historical procurement pricing trends for similar items compared to the newly negotiated prices.
Percentage of cost savings achieved through AI-driven negotiation strategies.
Breakdown of supplier counteroffers and the final accepted price.
Risk mitigation measures taken, including suppliers that were flagged, removed, or replaced.

Once the negotiation is finalized, the user can:
Approve the pricing to move forward with procurement.
Incorporate additional agents into the workflow, such as the Award Agent and Contract Negotiation Agent, to automatically finalize supplier selection and contract execution.
Trigger compliance validation, ensuring regulatory adherence before issuing a purchase order.

By providing transparent and data-driven insights, the system ensures that procurement teams can make well-informed decisions while minimizing manual effort and maximizing cost savings.

### EXAMPLE

A leading automotive manufacturer needs to procure 500 high-strength aluminium sheets for a new vehicle model. The system and method for flexible agentic autonomous negotiation process facilitates the procurement through the following agents in the sequence as described below:
1 Create Event Agent: The procurement team enters details for 500 high-strength aluminium sheets, specifying thickness, durability standards, and delivery deadlines. The system automatically creates a procurement event and moves to supplier selection.
2. Supplier Selection Agent: The system retrieves historical procurement records, evaluates supplier ratings, and checks pre-approved supplier databases. Five eligible suppliers are identified based on past performance and compliance with quality standards.
3. Bid Collection Agent: The selected suppliers are invited to submit their quotes within 48 hours. The system ranks the bids based on cost, lead time, and supplier performance.
4. Negotiation Agent: The top three suppliers are shortlisted based on their bid competitiveness and reliability. A base price is calculated from:
Past aluminium sheet purchases
Live market data from commodity indices
Supplier pricing trends in past cycles
The system determines negotiation modes:
Supplier A (Aggressive Pricing)→Hard Negotiation Mode
Supplier B (Reliable Supplier)→Medium Negotiation Mode
Supplier C (Expedited Delivery)→Easy Negotiation Mode

The system executes multiple negotiation rounds, dynamically adjusting counteroffers. The system applies bundling to propose volume discounts and unbundling to extract the best prices for individual components. The Predictive AI component of the system analyses supplier responses, adjusting negotiation pauses and escalation tactics for optimal results.
5. Supplier Risk Agent: Before awarding, the system flags Supplier A for financial instability based on recent credit rating downgrades. The agent eliminates Supplier A and introduces Supplier D into negotiations.
6. Award Agent: Supplier B offers the most balanced price, risk profile, and delivery timeline. The system finalizes the award and generates an automated report comparing:
Initial vs. final negotiated prices
Projected savings and performance benchmarks
7. Contract Negotiation Agent: The system auto-generates the procurement contract with the negotiated terms. Digital contract execution is done via blockchain-backed verification. Compliance checks are performed, and the contract is finalized.

Through this automated process, the manufacturer achieves:
18% cost savings through AI-driven negotiations.
Elimination of risky suppliers, ensuring procurement security.
40% faster procurement cycle, reducing overhead costs.
Seamless contract execution, ensuring compliance and efficiency.

Advantages:

The system and method of the present invention focuses on providing deep value as a self-driven assistant that requires just one user command and input, after which all procurement activities are automatically executed through an agentic-driven flow. The system eliminates the need for human intervention at each step, ensuring a seamless, intelligent, and optimized procurement process.

This system enables:

Autonomous supplier selection and engagement by leveraging real-time data, historical procurement records, and AI-driven risk evaluation models.

Self-adaptive negotiation workflows that dynamically adjust negotiation tactics based on supplier responses, competition levels, and pricing benchmarks.

Intelligent bid evaluation and risk management, ensuring suppliers are automatically assessed for credibility, past performance, and potential risks before finalizing agreements.

AI-powered predictive pricing analytics, allowing the system to autonomously determine the most effective negotiation strategy (hard, medium, or easy) to maximize cost efficiency while balancing supplier relationships.

End-to-end contract execution automation, reducing procurement cycle time and ensuring seamless compliance and finalization of agreements.

While considerable emphasis has been placed herein on the specific elements of the preferred embodiment, it will be appreciated that various modifications and adaptations can be made without departing from the principles of the invention. These and other refinements in the preferred embodiments will be apparent to those skilled in the art from the disclosure herein. The foregoing description is to be interpreted as illustrative rather than limiting the scope of the present invention.

What is claimed is:

1. A system for flexible agentic autonomous negotiation process that orchestrates procurement negotiation workflow by leveraging procurement agents that continuously assess supplier behaviour, market trends, and historical data characterised in that:
the system comprises an input unit, a processing unit and an output unit, wherein the processing unit employs the workflow for assisting procurement related negotiation by procurement agents;
wherein the system is operable to execute the steps of:
entering the requirements in the input unit by a user;
employing procurement agents that create customized procurement workflows based on specific business needs;
creating a structured, intelligent, and autonomous orchestration of procurement tasks from initiation to contract finalization by the procurement agents;
adding or removing procurement agents by users in the negotiation workflow;
incorporating real-time supplier risk assessment into the negotiation process to mitigate procurement risks and ensure supply chain reliability; and
providing a comprehensive negotiation performance report upon finalizing the procurement event.

2. The system as claimed in claim 1, wherein the procurement agents are selected from a create event agent, a supplier selection agent, a bid collection agent, a negotiation agent, a supplier risk agent, an award agent, and a contract negotiation agent.

3. The system as claimed in claim 1, wherein the create event agent generates a procurement event based on user input for an item description, quantity, and timelines, wherein the supplier selection agent identifies eligible suppliers based on historical transactions, supplier performance ratings, and pre-configured supplier eligibility criteria, wherein the bid collection agent invites the shortlisted suppliers to submit their bids within a defined timeframe, wherein the negotiation agent sets a base price and executes negotiations with top suppliers using dynamic pricing strategies, wherein the supplier risk agent assesses supplier risks only when a potential risk is detected based on system assessment, wherein the award agent automatically finalizes the procurement award based on the best-negotiated price and supplier risk assessment, wherein the contract negotiation agent facilitates contract execution post-negotiation, ensuring compliance and finalization of terms.

4. The system as claimed in claim 1, wherein the system is flexible and allows system-driven and user-driven modifications to the negotiation workflow by dynamic agent activation, user driven customization and configurable execution.

5. The system as claimed in claim 1, wherein the negotiation agent automatically shortlists the top suppliers based on pricing, past performance, delivery timelines, and risk assessment.

6. The system as claimed in claim 1, wherein the negotiation agent sets a base price derived from multiple sources:
historical procurement data from past transactions where the system retrieves past procurement records stored in an internal database, categorizing transactions by item type, quantity, supplier, and price trends over time;
publicly available market price quotes where the system integrates with external APIs that pull live pricing information from commodity exchange platforms, supplier marketplaces, and industry reports which ensures the pricing model reflects current market conditions;
wherein the system maintains a repository of past bid submissions from various suppliers and provides a comparative pricing analysis evaluates past bid trends for similar products, identifying pricing behaviour and supplier competitiveness.

7. The system as claimed in claim 1, wherein the negotiation agent initiates price discussions, asking suppliers to provide counteroffers based on this base price and the system determines the appropriate negotiation mode to be used based on the item category, supplier type, historical procurement records, heuristic patterns, market trends, and supplier discount history.

8. The system as claimed in claim 1, wherein the system evaluates prior interactions with suppliers, their pricing flexibility, and their negotiation behaviours to select one of the following negotiation strategies:
hard negotiation that focuses on maximum cost savings with aggressive counteroffers and is used for high-margin items, low-risk suppliers, and price-competitive markets;
medium negotiation that uses a balanced approach that considers long-term supplier relationships while optimizing pricing and is applied to strategic suppliers or procurement where long-term reliability is a key factor;
easy negotiation that ensures faster deal closures with reasonable pricing adjustments and is used for time-sensitive procurement needs or cases where supplier constraints limit pricing flexibility.

9. The system as claimed in claim 1, wherein the supplier risk agent can automatically reject the supplier from the negotiation process; introduce an alternative supplier into the workflow; and trigger additional risk mitigation measures, such as requesting updated compliance documents or conducting enhanced due diligence if a selected supplier has negative financial indicators, legal disputes, or recent supply chain disruptions and the supplier risk agent assesses risk by analysing real-time business news for legal or financial red flags; evaluating past procurement records for delayed deliveries, price fluctuations, or compliance breaches; conducting automated supplier risk scoring, flagging high-risk vendors for further review.

10. The system as claimed in claim 1, wherein the system provides a comprehensive negotiation performance report upon finalizing the procurement event that includes historical procurement pricing trends for similar items compared to the newly negotiated prices, a percentage of cost savings achieved through negotiation strategies, a breakdown of supplier counteroffers and the final accepted price, and risk mitigation measures taken, including suppliers that were flagged, removed, or replaced.
